(19) United States
(12) Patent Application Publication
(10) Pub. No.: US 2016/0259568 A1
(43) Pub. Date: Sep. 8, 2016

(54) METHOD AND APPARATUS FOR STORING DATA

(71) Applicants: Knut S. GRIMSRUD, Forest Grove, OR (US); Jawad B. KHAN, Cornelius, OR (US)

(72) Inventors: Knut S. GRIMSRUD, Forest Grove, OR (US); Jawad B. KHAN, Cornelius, OR (US)

(21) Appl. No.: 15/025,935

(22) PCT Filed: Nov. 26, 2013
(86) PCT No.: PCT/US2013/071842

§ 371 Date: Mar. 30, 2016

(51) Int. Cl. G06F 3/06; G06F 13/42

(52) U.S. Cl. CPC G06F 3/0613; G06F 3/0661; G06F 3/0683; G06F 3/0685; G06F 13/4282; G06F 2213/0026

(57) ABSTRACT

An SSD controller operates as an interface device conversant in a host protocol and a storage protocol supporting respective host and storage interfaces for providing a host with a view of an entire storage system. The host has visibility of the storage protocol that presents the storage system as a logical device, and accesses the storage device through the host protocol which is adapted for accessing high speed devices such as solid state drives (SSDs). The storage protocol supports a variety of possible dissimilar devices, allowing the host effective access to a combination of SSD and traditional storage as defined by the storage system. In this manner, a host protocol such as NVMe (Non-Volatile Memory Express), well suited to SSDs, permits efficient access to storage systems, such as a storage array, thus the entire storage system (array or network) is presented to an upstream host as an NVMe storage device.

### BACKGROUND

A solid state drive (SSD) is a high performance storage device that contains no moving parts. SSDs are much faster than typical hard disk drives (HDD) with conventional rotating magnetic media, and typically include a controller to manage data storage. The controller manages operations of the SSD, including data storage and access as well as communication between the SSD and a host device. Since SSDs are significantly faster than their predecessor HDD counterparts, computing tasks which were formerly I/O (Input/output) bound (limited by the speed with which non-volatile storage could be accomplished) may find the computing bottleneck limited by the speed with which a host can queue requests for I/O. Accordingly, host protocols such as PCIe® (Peripheral Component Interconnect Express, or PCI Express®) purport to better accommodate this new generation of non-volatile storage.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a computing and storage environment suitable for use with configurations herein;

FIG. 2 is a flowchart of the disclosed approach in the environment of FIG. 1;

FIG. 3 is a block diagram of an interface device for use with the approach of FIG. 2;

FIG. 4 shows the interface device of FIG. 3 in greater detail;

FIG. 5 shows a redundant configuration of the interface device of FIG. 4; and

FIG. 6 shows an interconnection of storage elements in the environment of FIG. 1.

### DETAILED DESCRIPTION

An SSD controller operates as an interface device conversant in a host protocol and a storage protocol supporting respective host and storage interfaces for providing a host with a view of a storage device. The host has visibility of the storage protocol that presents the storage device as a logical device, and accesses the storage device through the host protocol which is well adapted for accessing high speed devices such as solid state drives (SSDs). Since the host is presented with a storage device interface, while the storage protocol supports a plurality of devices, the storage interface may include multiple devices, ranging up to an entire storage array. The storage protocol supports a variety of possible dissimilar devices, allowing the host effective access to a combination of SSD and traditional storage as defined by the storage device. The individual storage devices are connected directly to the storage system which is being exposed as a single NVMe device to the host (current NVMe specifications are available at nvmexpress.org). In this manner, a host protocol such as NVMe (Non-Volatile Memory Express), well suited to SSDs, permits efficient access to a storage device, such as a storage array or other arrangement of similar or dissimilar storage entities, thus the entire storage system (storage array, network, or other suitable configuration) is presented to an upstream host as an NVMe storage device.

In contrast to conventional NVMe devices, which present a single SSD to a host, the approach disclosed herein “reverses” an NVMe interface such that the interface “talks” into a group, set or system of storage elements making the system appear from the outside as an SSD. The resulting interface presents as a direct-attached PCIe storage device that has an NVMe interface to the host, but has the entire storage system behind it, thus defining a type of NVMe Direct Attached Storage device (NDAS).

Configurations herein propose a NVMe direct attached storage (NDAS) system by exposing one or more interface(s) that perform emulation of a NVMe target register interface to an upstream host or an initiator, particularly with PCIe® (Peripheral Component Interconnect Express, or PCI Express®). The NDAS system allows flexibility in abstracting various and possibly dissimilar storage devices which can include SATA (serial Advanced Technology Attachment, current specifications available at sata-io.org) HDDs (hard disk drives), SATA SSDs and PCIe/NVMe SSDs with NAND or other types of non-volatile memory. The storage devices within the NDAS system could then be used to implement various storage optimizations, such as aggregation, caching and tiering.

By way of background, NVMe is a scalable host controller interface designed to address the needs of enterprise, data center and client systems that may employ solid state drives. NVMe is typically employed as an SSD device interface for presenting a storage entity interface to a host. Configurations herein define a storage subsystem interface for an entire storage solution (system), but which appears as an SSD by presenting a SSD storage interface upstream. NVMe is based on a paired submission and completion queue mechanism. Commands are placed by host software into the submission queue. Completions are placed into an associated completion queue by the controller. Multiple submission queues may utilize the same completion queue. The submission and completion queues are allocated in host memory.

PCIe is a high-speed serial computer expansion bus standard designed to replace older PCI, PCI-X, and AGP bus standards. PCIe implements improvements over the aforementioned bus standards, including higher maximum system bus throughput, lower I/O pin count and smaller physical footprint, better performance-scaling for bus devices, and a more detailed error detection and reporting mechanism. NVM Express defines an optimized register interface, command set and feature set for PCI Express-based solid-state drives (SSDs), and is positioned to utilize the potential of PCIe SSDs, and standardize the PCIe SSD interface.

A notable difference between PCIe bus and the older PCI is the bus topology. PCI uses a shared parallel bus architecture, where the PCI host and all connected devices share a common set of address/data/control lines. In contrast, PCIe is based on point-to-point topology, with separate serial links connecting every device to the root complex (host). Due to its shared bus topology, access to the older PCI bus is typically arbitrated (in the case of multiple masters), and limited to one master at a time, in a single direction. Also, the older PCI clocking scheme limits the bus clock to the slowest peripheral on the bus (regardless of the devices involved in the bus transaction). In contrast, a PCIe bus link supports full-duplex communication between any two endpoints, and therefore promotes concurrent access across multiple endpoints.

Configurations herein are based on the observation that current host protocols, such as NVMe, for interacting with mass storage or non-volatile storage, tend to be focused on a particular storage device or type of device and may not be well suited to accessing a range of devices. Unfortunately, conventional approaches to host protocols do not lend sufficient flexibility to the arrangement of mass storage devices servicing the host. For example, most personal and/or portable computing devices employ a primary mass storage device, and usually this is vendor matched with the particular device. For example, most off-the-shelf laptops, smartphones, and audio devices are shipped with a single storage device selected and packaged by the vendor. Conventional devices may not be focused on access to other devices because such access deviates from an expected usage pattern.

Accordingly, configurations herein substantially overcome the above described shortcomings by providing an interface device, or bridge, that exposes a host-based protocol (host protocol), such as NVMe to a user computing device, and employs a storage-based protocol (storage protocol) for implementing the storage and retrieval requests, thus broadening the sphere of available devices to those recognized under the storage protocol. For example, NDAS (Network Direct Attached Storage) allows a variety of different storage devices to be interconnected and accessed via a common bus by accommodating different storage mediums (SSD, HDD, Optical) and device types (i.e. differing capacities) across the common bus. All users or systems on the network can directly control, use and share the interconnected storage devices. In this manner, the host based protocol presents an individual storage device to a user, and a mapper correlates requests via the host protocol to a plurality of storage elements (i.e. individual drives or other devices) via the storage protocol, thus allowing the plurality of interconnected devices (sometimes referred to as a “storage array” or “disk farm”) to satisfy the requests even though the user device “sees” only a single device under the host protocol.

For example, NVMe facilitates access for SSDs by implementing a plurality of parallel queues for avoiding I/O bottlenecks and efficiently processing of requests stemming from multiple originators. Conventional HDDs are typically expected to encounter an I/O bound implementation, since computed results are likely to be generated faster than conventional HDDs can write them. NVMe is intended to lend itself well to SSDs (over conventional HDDs) by efficiently managing the increased rate with which I/O requests may be satisfied.

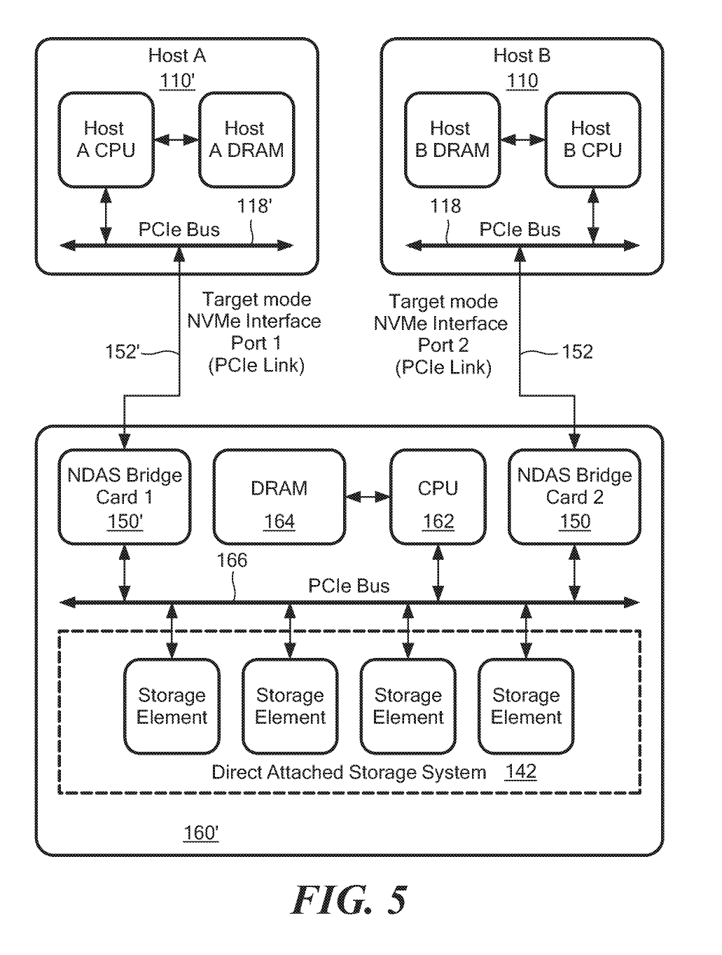

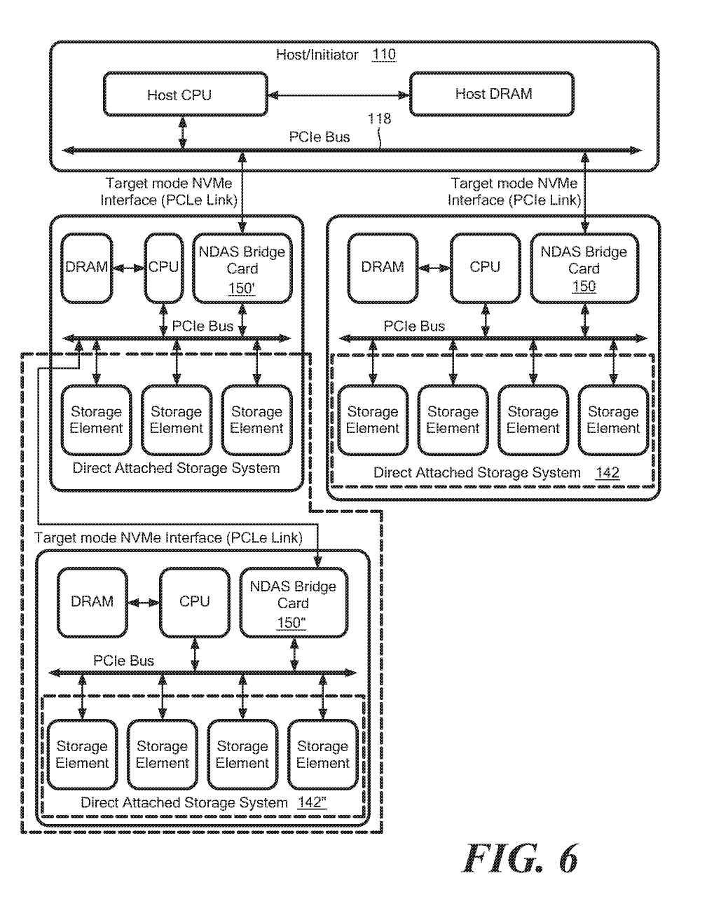

Depicted below is an example configuration of a computing and storage environment having an example configuration according to the system, methods and apparatus disclosed herein. A host computing device (host) interfaces with multiple networked storage devices using the storage interface device (interface device). The disclosed arrangement is an example, and other interconnections and configurations may be employed with the interface device, some of which are depicted further in FIGS. 5 and 6 below.

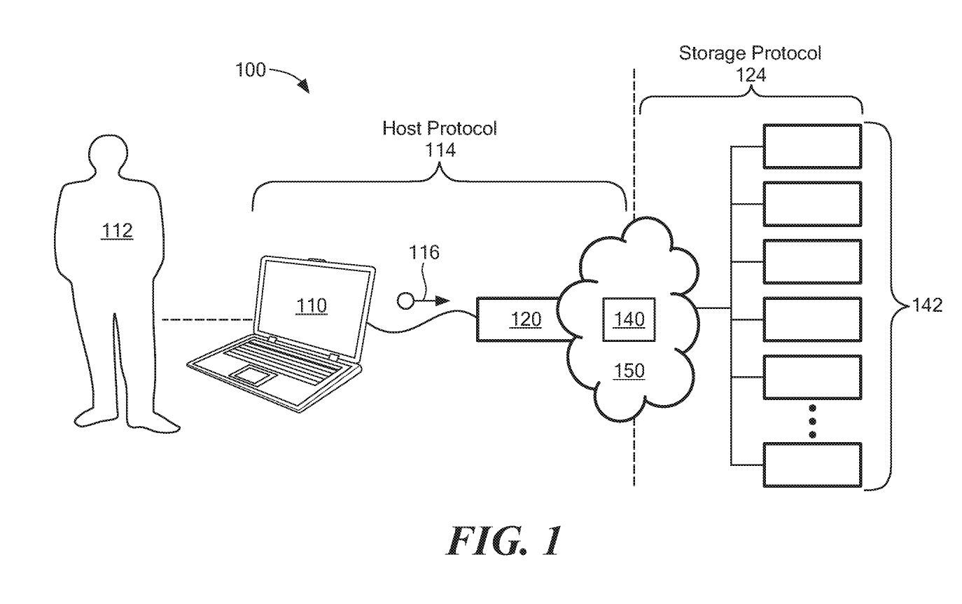

Referring to FIG. 1, a context diagram of a computing and storage environment 100 suitable for use with configurations herein is shown. In the computing and storage environment 100, a host system (host) 110 is responsive to one or more users 112 for computing services. The host 110 employs a storage device 120, such as an SSD, which may be internal or external to the host 110. The host 110 interacts with the storage device 120 by issuing requests 116 via a host protocol 114 recognized by the storage device 120. In configurations herein, a storage protocol 124 satisfies the requests 116 using a set or plurality of storage elements 142 via a mapper 140, which presents the host protocol 114 to the host 110 (user device) and correlates the requests 116 to the plurality of storage elements 142 using the storage protocol 124. The mapper 140 takes the form of an interface device (shown as cloud 150) that bridges or correlates requests and responses between the host protocol 114 and storage protocol 124.

The example of FIG. 1 depicts a high level architecture of the disclosed system with the interface device 150. In one usage scenario the interface device 150 is an NVMe bridge card for interfacing between a host/initiator and an NDAS system. Several dissimilar storage elements may be employed in the NDAS system for providing a backend store. These elements could be in the form of SATA HDDs, SATA SSDs, PCIe SSDs, NVMe SSDs or other NDAS systems. Various end-user devices may be envisioned to benefit with this approach, including caching solutions where host writes could be cached to faster but expensive NVM devices and later flushed to inexpensive but slower NVM storage devices. Tiering solutions could be envisioned where two different types of backend NVM storage devices are used. In multi-port implementations this system could also provide high-availability capability.

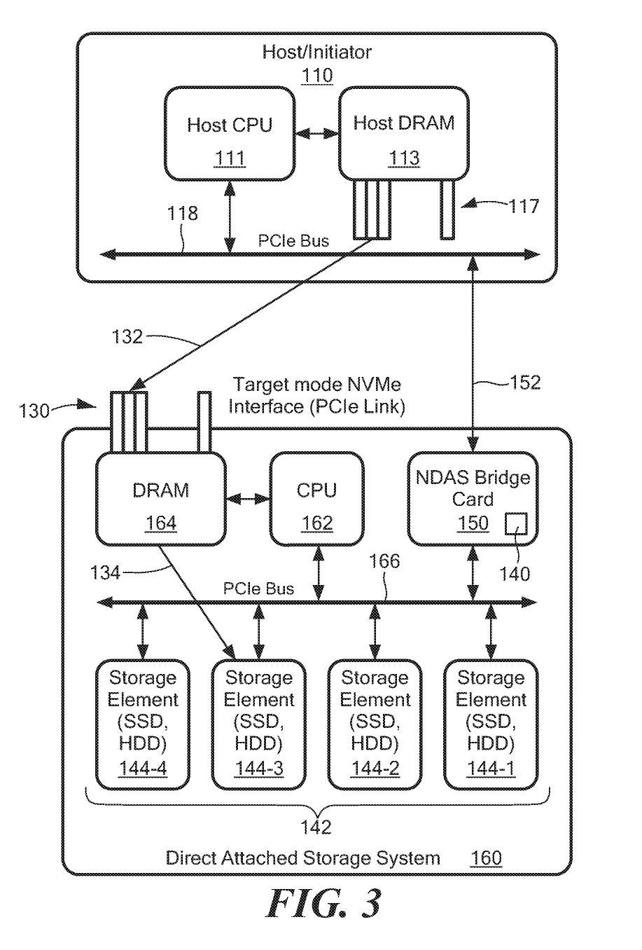

In the example of FIG. 1, and also in FIG. 3 discussed further below, the interface device 150 takes the form of an NVMe bridge card that may be used in an off-the-shelf server system for implementing an NVMe Direct Attached Storage System. The NVMe Bridge card exposes the NVMe protocol to the upstream host/initiator 110 by exposing a fully compliant NVMe interface. On the downstream side, the interface device 150 provides PCIe functionality with a simplified NVMe interface for connectivity to the NDAS system, defined by the plurality of storage elements 142. The interface device 150 has optimal physical interface capabilities, such as gold fingers for connectivity to the NDAS system and cable connectors for connectivity to the host/initiator systems. The interface device 150 may expose one or more ports to the upstream initiator/host and as a result the entire NDAS system is presented to the upstream initiator/host as an NVMe storage device.

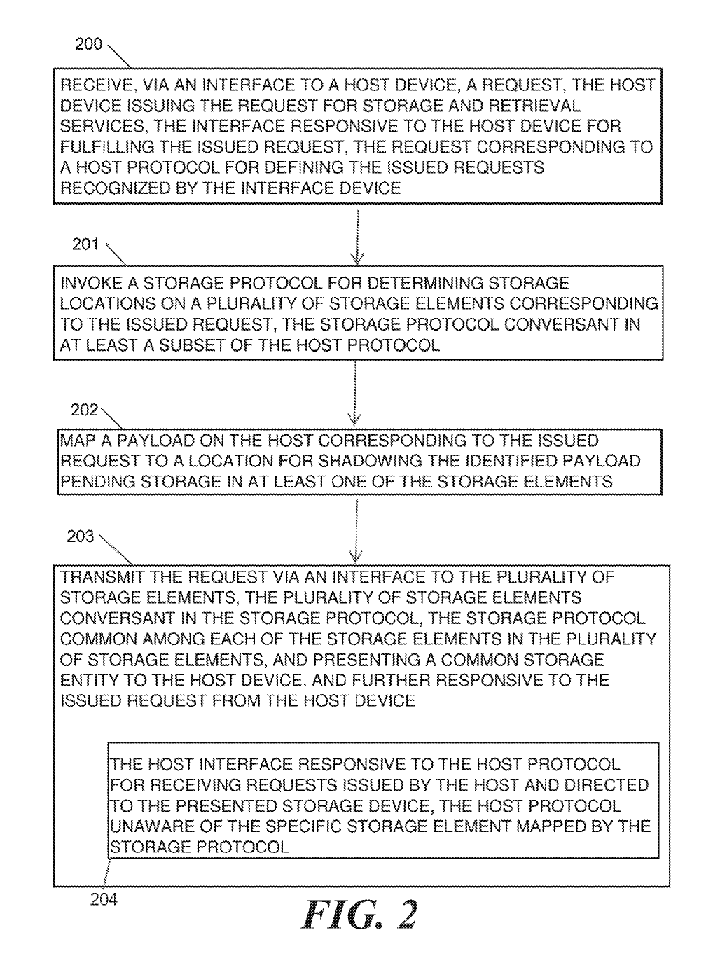

FIG. 2 is a flowchart of the disclosed approach in the environment of FIG. 1. Referring to FIGS. 1 and 2, the method for storing data on a storage device via an interface device 150 as shown and disclosed herein includes, at step 200, receiving, via an interface to a host device 110, a request 116, in which the host device 110 issues the request 116 for storage and retrieval services. The host interface is responsive to the host device 110 for fulfilling the issued request, in which the request corresponds to a host protocol 114 for defining the issued requests recognized by the interface device 150. The interface device 150 invokes a storage protocol 124 for determining storage locations on a plurality of storage elements 142 corresponding to the issued request 116, in which the storage protocol 124 is conversant in at least a subset of the host protocol 114, as depicted at step 201. The interface device 150 maps a payload on the host 110 corresponding to the issued request 116 to a location for shadowing the identified payload pending storage in at least one of the storage elements 142, as shown at step 202. This involves copying the payload from a queue on the host 110 to a transfer memory or buffer at the storage elements. Based on the mapping, the interface device 150 transmits the request 116 and associated payload via an interface to the plurality of storage elements 142, in which the plurality of storage elements 142 is conversant in the storage protocol 124, and the storage protocol is common among each of the individual storage elements in the plurality of storage elements, and presents a common storage entity to the host device 110, and is further responsive to the issued request 116 from the host device 110, as depicted at step 203. In the example arrangement, the host 110 employs the host protocol 114, such that the host interface is responsive to the host protocol 114 for receiving the requests 116 issued by the host 110 and directed to the presented storage device, while the host protocol 114 is unaware of the specific storage element mapped by the storage protocol. In other words, the host sees the plurality of storage elements 142 as a single storage device, consistent with its native host protocol, and the storage protocol handles mapping to a specific storage device and location.

FIG. 3 is a block diagram of an interface device for use with the approach of FIG. 2. Referring to FIGS. 1 and 3, in an example configuration, the host protocol (first protocol) is NVMe and the presented storage device is an NVMe drive, and the storage protocol (second protocol) is NDAS and the storage elements comprise at least one of a SATA SSD, SATA HDD, PCIe SSD, NVMe SSD, flash, or NAND based mediums. In this example configuration, the host 110 includes a processor 111 and memory 113, coupled to an I/O path 152 via a local PCIe bus 118. In the example shown, the interface device 150 takes the form of an NDAS bridge card for communicating with the plurality of storage elements 142. The storage elements 142 are connected as a direct attached storage system 160 configured with NDAS, including the interface device 150, a processor 162, local memory (DRAM) 164, and a bus 166 interconnection, such as a PCIe bus or other Ethernet based bus, for coupling each of the individual storage elements 144-1 . . . 144-4 (144 generally) according to the storage protocol 124.

The host protocol 114 defines a plurality of host queues 117, including submission and completion queues, for storing commands and payload based on the requests 116 pending transmission to the interface device 150. The mapper 140 maintains a mapping 132 to transfer queues 130 defined in the local memory 164 on the NDAS side for transferring and buffering the data before writing the data to a storage element 144-3 according to the storage protocol 124, shown as example arrow 134.

The interface device 150, therefore, includes a host interface responsive to requests issued by a host 110, such that the host interface presents a storage device for access by the host 110. The storage protocol 124 defines all of the plurality of storage elements 142 as a single logical storage volume. In the device 150, a storage interface couples to a plurality of dissimilar storage devices, such that the plurality of storage devices are conversant in a storage protocol common to each of the plurality of storage devices. The storage protocol coalesces logical and physical differences between the individual storage elements so that the storage protocol can present a common, unified interface to the host 110. The mapper 140 connects between the host interface and the storage interface and is configured to map requests 116 received on the host interface to a specific storage element 144 connected to the storage interface, such that the mapped request 116 is indicative of the specific storage element based on the storage protocol, and the specific storage element 144 is independent of the presented storage device so that the host protocol need not specify any parameters concerning which storage element to employ.

The interface device 150 includes FIFO transfer logic in the mapper 140, in which the FIFO transfer logic is for mapping requests received on the host interface to a specific storage element 144 connected to the storage interface, and such that the mapped request is indicative of the specific storage element 144 based on the storage protocol 124. The host interface presents a single logical storage device corresponding to the plurality of storage elements, and each of the dissimilar storage elements is responsive to the storage protocol for fulfilling the issued requests.

In the example configuration, employing NVMe as the host protocol, NVMe provides an interface to a plurality of host queues 117, such that the host queues further include submission queues and completion queues, and in which the submission queues are for storing pending requests and a corresponding payload, and the completion queues indicate completion of the requests. The submission queues further include command entries and payload entries. A plurality of queues is employed because the speed of SSDs would be compromised by a conventional, single dimensional (FIFO) queue structure, since each request would be held up waiting for a predecessor request to complete. Submission and completion queues allow concurrent queuing and handling of multiple requests so that larger and/or slower requests do not impede other requests 116.

In the case of NVMe as the host protocol, the usage of the queues further comprising an interface to the shadow memory, defined in FIG. 3 by the local memory 164, such that the interface is responsive to the interface device 110 for transferring payload entries from the host 110 to the shadow memory. The shadow memory stores payload from the submission queue until a corresponding command entry is received by the backend logic 124′ for managing the plurality of storage elements 142. The mapper 140 is responsive to the backend logic 124′ for identifying a storage element 144 in the plurality of storage elements 142, and storing the payload entry in an identified storage element 144 based on the storage protocol 124.

On the storage protocol side, each of the storage elements 144 may be any suitable physical storage device, such as SSDs, HDDs, optical (DVD/CD), or flash/NAND, and may be a hub or gateway to other devices, thus forming a hierarchy (discussed further below in FIG. 6. Each of the storage devices 144 is conversant in the storage protocol 124, NDAS in the disclosed example, and is presented to the host 110 via the interface device 150 as a single logical storage element according to the host protocol 114.

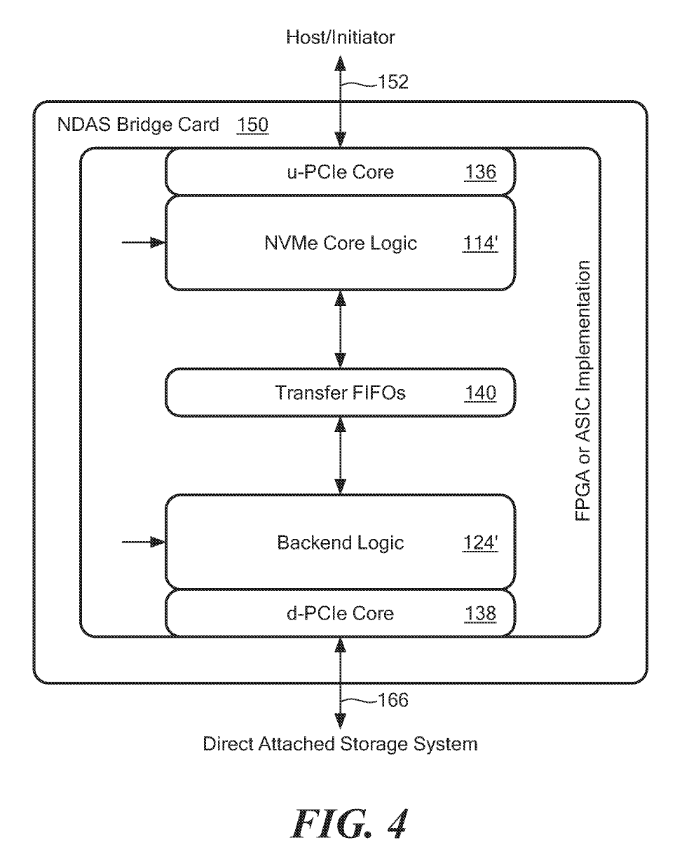

FIG. 4 shows more details about the NVMe Bridge Card architecture for a single port implementation, for ease of understanding the concept (multiple ports are possible and envisioned). Two PCIe cores are present in the NVMe Bridge Card: one PCIe core provides connectivity to the upstream host initiator and a second PCIe core provides connectivity to NDAS system. The NVMe protocol is therefore exposed to the upstream host and the NDAS side logic provides a simplified NVMe protocol, for attachment to the NDAS system.

In FIG. 4, the interface device of FIG. 3 is shown in greater detail. Referring to FIGS. 3 and 4, the interface device 150 includes a host network core 136 responsive to the host protocol core logic 114′, and a storage network core 138 responsive to the storage network protocol (backend) logic 124′ and conversant in a subset of the host protocol 114.

In the example arrangement, in addition to the submission and completion queues defined by the NVMe protocol, the simplified NVMe protocol in the backend logic 124′ includes direct mapped locations for data buffers for each command in a particular submission queue 117. The interface device may take any suitable physical configuration, such as within an SSD, as an card in a host or storage array device, or as a standalone device, and may include a microcontroller/processor. Alternatively, the interface device 150 may not require an on-board processor, but rather its functions are either HW automated or controlled by the NDAS driver/SW. The upstream host 110 system uses NVMe driver for communicating with the NVMe NDAS system. The NDAS system would load a custom driver for the simplified NVMe protocol and would run a custom software application for controlling the functionality of the interface card 150 and responds to the NVMe commands being issued by the host/initiator 110 and manages all the downstream storage devices 144 as well.

The host protocol 114 is a point-to-point protocol for mapping the requests 116 from the plurality of host queues 117 to a storage element 144, and the storage protocol is responsive to the host protocol 114 for identifying a storage element 144 for satisfying the request, the host protocol referring only to the request and unaware of the storage element handling the request. Accordingly, each of the host queues corresponds to a point-to-point link between the host and the common storage entity. The completion queues are responsive to the host protocol for identifying completed requests based on the host protocol, the host protocol for mapping requests to a corresponding completion entry in the completion queues.

FIG. 5 shows a redundant configuration of the interface device of FIG. 4. Referring to FIGS. 4 and 5, in a particular configuration, a plurality of interface devices 150, 150′ are responsive to a plurality of hosts 110, 110′. In the example shown, a plurality of I/O paths 152, 152′ couple the respective hosts 110, 110′ to the interface devices 150, 150′ and then to a common bus interconnection 166 on the storage element (storage protocol 124) side. Either of hosts 110, 110′ can issue requests 116 for which the interface devices 150, 150′ have access to the entire plurality of storage arrays 142. Such a configuration is beneficial in resilient installations where a plurality of hosts employ redundancy techniques such as volume shadowing and RAID (Redundant Array of Interconnected Disks) arrangements.

In the example configuration of FIG. 5, a storage device 110 employs a dual port NDAS architecture which exposes two NVMe ports for I/O paths 152, 152′ to the upstream hosts 110, 110′ using two discrete NDAS bridge cards as interface devices 150, 150′. Native dual port connectivity on a single NDAS bridge card is also envisioned. These ports work in the active/active mode and are connected respectively to the two different upstream hosts 150, 150′. These hosts can access data on the NDAS system, while any semantics for mutual exclusivity could be implemented by the hosts or in the NDAS system through the use of NVMe reservations. If one of the hosts 110, 110′ goes down, the dual port option also provides a fail-over mechanism so that the other host can take over and has access to all data stored thus far. A plurality of ports may also be employed by the disclosed architecture. Other configurations may employ a plurality of interface devices 150, such that each of the plurality of interface devices couples to a plurality of hosts 110, and each of the hosts 110 has access to the plurality of storage elements 142 via each of the interface devices 110.

FIG. 6 shows an interconnection of storage elements in the environment of FIG. 1. Referring to FIG. 6, a plurality of interface devices 150 are arranged in a hierarchical structure. In the configuration of FIG. 6, an interface device 150″ connects as a storage element 144 to interface device 150′. The entire plurality of storage devices 142″ is seen included as a single storage element 144 of the storage devices 142′. This arrangement may be employed to provide staging or queuing in which the plurality of storage elements 142 is defined by a hierarchy of storage devices, such that the storage devices including higher throughput devices for caching data for storage on slower throughput devices

FIG. 6 therefore allows for a hierarchy or layered NDAS storage architecture by simply plugging an NDAS system as a storage device into another NDAS system. A tree of such systems could be devised for very large capacity/performance system. In such an architecture, the common storage entity is an NVMe storage device, and each of the plurality of storage entities are NDAS conversant.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

1. An interface device, comprising:
a host interface responsive to requests issued by a host, the host interface presenting a storage device for access by the host;
a storage interface coupled to a plurality of dissimilar storage elements, the plurality of storage elements conversant in a storage protocol common to each of the plurality of storage elements; and
a mapper connected between the host interface to the storage interface and configured to map requests received on the host interface to a specific storage element connected to the storage interface, the mapped request indicative of the specific storage element based on the storage protocol, the specific storage element independent of the presented storage device.

2. The device of claim 1 further comprising a host protocol, the host interface responsive to the host protocol for receiving requests issued by the host and directed to the presented storage device, the host protocol unaware of the specific storage element mapped by the storage protocol.

3. The device of claim 2 further comprising FIFO transfer logic in the mapper, the FIFO transfer logic for mapping requests received on the host interface to a specific storage element connected to the storage interface, the mapped request indicative of the specific storage element based on the storage protocol.

4. The device of claim 1 wherein the host interface presents a single logical storage device corresponding to the plurality of storage elements, and each of the dissimilar storage elements is responsive to the storage protocol for fulfilling the issued requests.

5. The device of claim 4 wherein the storage protocol is NDAS and the storage elements comprise at least one of a SATA SSD, SATA HDD, PCIe SSD, NVMe SSD, Flash, or NAND based mediums.

6. The device of claim 5 wherein the host protocol is NVMe and the presented storage device is an NVMe drive.

7. The device of claim 1 further comprising an interface to a plurality of host queues, the host queues further including submission queues and completion queues, the submission queues for storing pending requests and a corresponding payload, and the completion queues indicating completion of the requests.

8. The device of claim 7 wherein the host protocol is a point-to-point protocol for mapping requests from the plurality of host queues to a storage entity, and the storage protocol is responsive to the host protocol for identifying a storage element for satisfying the request, the host protocol referring only to the request and unaware of the storage element handling the request.

9. The device of claim 7 further comprising an interface to a shadow memory, the interface responsive to the device for transferring payload entries from the host to the shadow memory, the shadow memory for storing payload from the submission queue until a corresponding command entry is received by backend logic for managing the plurality of storage elements; and
the mapper responsive to the backend logic for:
identifying a storage element in the plurality of storage elements; and
storing the payload entry in an identified storage element based on the storage protocol.

10. The device of claim 1 wherein the plurality of storage elements is defined by a hierarchy of storage devices, the storage devices including higher throughput devices for caching data for storage on slower throughput devices.

11. The device of claim 1 further comprising a plurality of interface devices, each of the plurality of interface devices coupled to a plurality of hosts, each of the hosts having access to the plurality of storage elements via each of the interface devices.

12. A method of storing data on a storage network, comprising:
receiving, via an interface to a host device, a request, the host device issuing the request for storage and retrieval services, the interface responsive to the host device for fulfilling the issued request, the request corresponding to a host protocol for defining the issued requests recognized by the interface device;
invoking a storage protocol for determining storage locations on a plurality of storage elements corresponding to the issued request, the storage protocol conversant in at least a subset of the host protocol;
mapping, via the invoked storage protocol, a payload on the host corresponding to the issued request to a location for shadowing the identified payload pending storage in at least one of the storage elements; and
transmitting the request via an interface to the plurality of storage elements, the plurality of storage elements conversant in the storage protocol, the storage protocol common among each of the storage elements in the plurality of storage elements, the storage protocol presenting a common storage entity to the host device, and further responsive to the issued request from the host device.

13. The method of claim 12 further comprising mapping the request received on the host interface to a specific storage element connected to the storage interface, the mapped request indicative of the specific storage element based on the storage protocol.

14. The method of claim 13 wherein the host interface presents a single logical storage device corresponding to the plurality of storage elements, and each of the dissimilar storage elements is responsive to the storage protocol for fulfilling the issued requests.

15. The method of claim 12 wherein the host protocol is unaware of the specific storage element mapped by the storage protocol.

16. The method of claim 15 wherein the storage protocol is NDAS and the storage elements comprise at least one of a SATA SSD, SATA HDD, PCIe SSD, NVMe SSD, Flash, or NAND based mediums.

17. The method of claim 15 wherein the host protocol is NVMe and the presented storage device is an NVMe drive.

18. The method of claim 12 further comprising receiving the request from one of a plurality of host queues, the host queues further including submission queues and completion queues, the submission queues for storing pending requests and a corresponding payload, and the completion queues indicating completion of the requests.

19. The method of claim 12 wherein the host protocol is a point-to-point protocol for mapping requests from the plurality of host queues to a storage entity, and the storage protocol is responsive to the host protocol for identifying a storage element for satisfying the request, the host protocol referring only to the request and unaware of the storage element handling the request.

20. A computer program product having instructions encoded on a non-transitory computer readable storage medium that, when executed by a processor, perform a method of storing data on a storage network, comprising:
receiving, via an interface to a host device, a request, the host device issuing the request for storage and retrieval services, the interface responsive to the host device for fulfilling the issued request, the request corresponding to a host protocol for defining the issued requests recognized by the interface device;
invoking a storage protocol for determining storage locations on a plurality of storage elements corresponding to the issued request, the storage protocol conversant in at least a subset of the host protocol;
mapping, via the invoked storage protocol, a payload on the host corresponding to the issued request to a location for shadowing the identified payload pending storage in at least one of the storage elements; and
transmitting the request via an interface to the plurality of storage elements, the plurality of storage elements conversant in the storage protocol, the storage protocol common among each of the storage elements in the plurality of storage elements, the storage protocol presenting a common storage entity to the host device, and further responsive to the issued request from the host device.
